(19) United States
(12) Patent Application Publication
(10) Pub. No.: US 2008/0010671 A1
(43) Pub. Date: Jan. 10, 2008

(54) Whitening functional unit and method

(76) Inventor: John Mates, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/450,111

(22) Filed: Jun. 9, 2006

(51) Int. Cl. G06F 17/30

(52) U.S. Cl. 726/4

(57) ABSTRACT

Approaches for reducing undesired chaotic behavior, improving security and/or reliability and/or decreasing performance excursions in an integrated circuit, system or group of systems. According to one aspect, a whitening functional unit is coupled to a first functional unit and acts to perturb the operation of the first functional unit in a substantially non-deterministic manner. For some aspects, the whitening functional unit may be responsive to events, control information, temporal information, one or more counters and/or other indicia to perturb the operation of the first functional unit.

### BACKGROUND

An embodiment of the present invention relates to the field of integrated circuit design and, more particularly, to an approach for controlling chaotic behavior, improving security associated with deterministic behavior, improving reliability and/or reducing performance excursions in microprocessors and/or other complex, deterministic state machines.

Computer system complexity continues to rise. As with all complex physical devices, the timing of the physical and logical events taking place within the architectures of these complex logic systems can interfere with one another, both destructively and constructively, creating temporal behaviors, which are essentially unpredictable. This observation applies to complex logic systems, whether implemented entirely on a single chip (e.g. modern microprocessors) or implemented as a collection of interacting complex logic chips. It has been proposed, for example, that microprocessors are now beginning to exhibit a form of the “butterfly effect,” yielding unpredictable performances, which may be delicately dependent on prior logic timing interactions.

Unpredictable performance can be problematic for a variety of reasons, key among them the fact that system users depend on reliable microprocessor behavior in executing code and controlling other system functions.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example microprocessor implementing a whitening functional unit according to one or more embodiments.

FIG. 2 is a block diagram of an example multi-core microprocessor implementing a whitening functional unit according to one or more embodiments.

FIG. 3 is a block diagram of another example multi-core microprocessor implementing a whitening functional unit according to one or more embodiments.

FIG. 4 is a block diagram of an example system in which a whitening functional unit of one or more embodiments may be advantageously implemented.

FIG. 5 is a block diagram of another example system in which a whitening functional unit of one or more embodiments may be advantageously implemented.

FIG. 6 is a flow diagram showing a method of one embodiment for controlling chaotic behavior.

### DETAILED DESCRIPTION

A method and apparatus for controlling chaotic behavior, improving security and/or reliability and/or reducing performance excursions in a microprocessor and/or other complex logic are described. In the following description, numerous specific details, such as particular types and arrangements of integrated circuit devices, logic, systems, circuits, etc. are described for purposes of illustration. It will be appreciated, however, that other embodiments are applicable to other types and/or arrangements of integrated circuit devices, logic, systems and circuits, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As described above, unpredictable behavior and/or performance excursions in a microprocessor or other complex logic arrangement can be problematic. For one embodiment, logic, such as a microprocessor, another type of integrated circuit device, a system or a group of systems, for example, includes a whitening functional unit (WFU). The whitening functional unit is provided to “whiten”, inject “noise” into, or otherwise perturb operation of one or more functional units and is capable of doing so in at least a partially non-determininstic, stochastic manner, in an attempt to control unpredictable performance excursions of the microprocessor, integrated circuit device, system or group of systems as described in more detail below. The term “functional unit” as described herein may refer to any type of functional unit ranging from a block of circuitry or logic in an integrated circuit device, to individual integrated circuit devices in a system and/or an individual system in a group of systems, for example. “Whitening Functional Unit” as used herein, however, may have a different definition as described further below and in the appended claims. Further, references to non-deterministic or substantially non-deterministic behavior or actions or perturbing operations in a substantially non-deterministic manner include behavior, actions or perturbation operations that are substantially unpredictable, except possibly in an overall statistical sense.

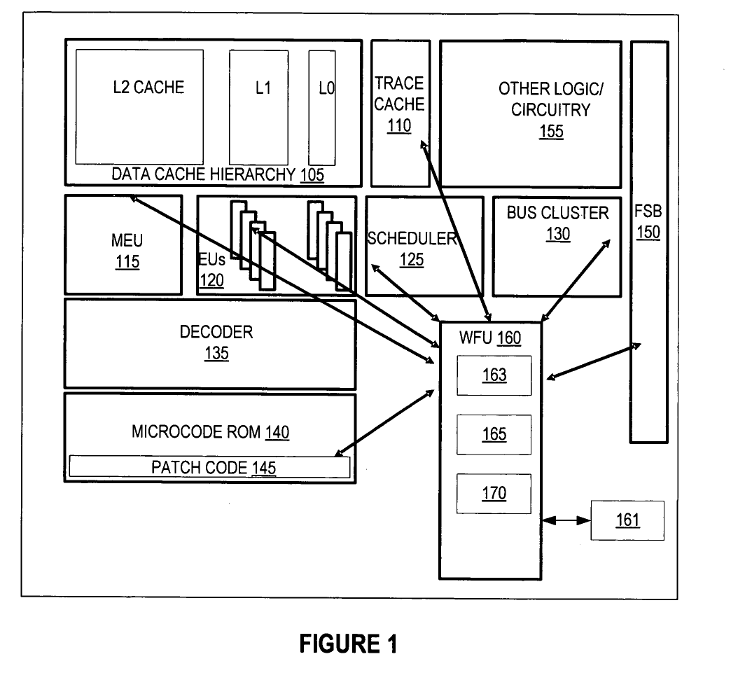

FIG. 1 is a block diagram of an example microprocessor 100 that incorporates a whitening functional unit 160 according to one embodiment. The example microprocessor 100 includes a data cache hierarchy 105, including level 2 (L2), level 1 (L1) and level 0 (L0) cache memories, a trace cache memory 110, a memory execution unit (MEU) 115, execution units (EUs) 120, which may include, for example, integer and floating point execution units, a scheduler 125, bus cluster 130, decoder 135, microcode (ucode) read-only memory (ROM) 140, which may include a patch code section 145, front side bus (FSB) 150 and other logic/circuitry 155.

While a specific example microprocessor configuration is shown in FIG. 1, it will be appreciated that microprocessors and/or other types of processors or integrated circuits arranged in a different manner and/or including different units may also advantageously implement a whitening functional unit of one or more embodiments.

The whitening functional unit 160 may be provided to centralize and/or generalize local approaches for controlling microprocessor 100 dynamics to reduce undesired, chaotic behaviors. At least some of the behavior controlled and/or initiated by the whitening functional unit may be substantially non-deterministic and/or stochastic in nature. The whitening functional unit of one or more embodiments may be capable of reducing chaotic behavior by intervening in one or more ways made available by the processor microarchitecture (or attributes of another integrated circuit, system or group of systems in which the whitening functional unit of one or more embodiments is implemented). Each of these various approaches for intervening may be referred to generally herein as “whitening,” “perturbing operation” or “inserting noise” into an operation or process associated with the respective processor, integrated circuit, or system.

For example, the whitening functional unit 160 of FIG. 1 is coupled to each of the microcode ROM 140, the MEU 115, the execution units 120, the scheduler 125, the trace cache 110, the bus cluster 130 and the front side bus 150, and is further coupled to have access to parameters (e.g. counter values) and/or other control-related features as required by the particular method(s) of chaos control that may be used (e.g. Ott-Grebogi-Yorke or OGY method, pink noise, etc.).

In operation, the whitening functional unit 160 may at least partially control aspect(s) of operation(s) of one or more of the units to which it is coupled or can otherwise affect, with a goal, for example, of reducing undesired chaotic behavior, and thereby reducing performance excursions. Other operations and purposes for the whitening functional unit of this and/or other embodiments are also described below.

For the example processor 100 of FIG. 1, the whitening functional unit 160 is coupled to the microcode ROM (uCode ROM) 140. The microcode ROM 140 may store one or more microcode flows defined to insert bubbles (e.g. null operations or micro-operations) into the execution paths or otherwise perturb operations of microcode-controllable portions of the processor 100. The design of the microcode flow(s) may be dependent on a variety of factors including the particular unit(s) for which they are to perturb operation and the extent of perturbation deemed helpful in reducing undesired chaotic behavior. For some embodiments, these flows may even be dynamically defined or defined after manufacture in the microcode patch space (patch code) 145.

For this example, to perturb operation(s) of one or more units on the processor 100, the whitening functional unit 160 may invoke one or more of the described microcode flow(s) in response to given event(s), counter value(s), pseudo-random information and/or other indicia, and/or according to a temporal pattern, such as a pseudo-random temporal pattern. For some embodiments, the whitening functional unit 160 may be responsive to different counter values, pseudo-random values, events, etc. to initiate and/or control similar or different actions associated with various units either concurrently or at different times. For such embodiments, as mentioned above, the whitening functional unit 160 may be coupled to receive the control, data, counter, timing and/or other information used to determine when and where to insert the bubbles or otherwise perturb operations.

For example, the whitening functional unit 160 may be coupled via control logic 163 or a whitening functional unit state machine 165 to circuitry 161. The circuitry 161 may be, for one embodiment, a pseudo-random number generator, a backward-biased diode and associated amplifier to generate pink noise, another source of noise or pseudo-random data, or a counter, for example. In response to the circuitry 161 reaching a predetermined count (where the circuitry 161 is a counter) or according to pseudo-random information (where the circuitry 161 is a pseudo-random number generator or other source of pseudo-random information), the whitening functional unit 160 may invoke one or more of the predefined or dynamically defined microcode flows stored in the microcode ROM 140 to inject noise into one or more functional units. While the circuitry 161 is illustrated as being external to the whitening functional unit 160, for other embodiments, it may be integrated into the whitening functional unit or in another location, either on or off the processor 100, that is accessible by the whitening functional unit 160.

Alternatively or additionally, the whitening functional unit 160 may be responsive to events or criteria associated directly with the unit in which noise is to be injected. For example, the whitening functional unit may be responsive to performance-related information such as high branch misprediction counts. In response to detecting a decline in a performance metric, which may be measured, for example, versus a predetermined threshold, the whitening functional unit 160 may implement one or more of the whitening approaches of various embodiments to perturb operations and reduce chaotic behavior. For some embodiments, the whitening actions may be continued until the performance-related information indicates that the performance is above the same or a different threshold. For other embodiments, the whitening actions may controlled in a different manner.

More specifically, in terms of some of the whitening actions that may be implemented, for the example of FIG. 1, the whitening functional unit 160 may, either directly, or indirectly through invoked code, for example, control the MEU 115 to vary cache latencies related to loads and stores (e.g. by inserting bubbles into memory buffers), control the bus cluster to add bubbles to loads and stores for main memory, whiten execution flow by controlling execution units 120 with pipelines (e.g. floating point operations) to insert bubbles into the pipeline, place null transactions on the front side bus, mark cache lines at random to be ejected from the cache at some later time(s) and/or generally control the scheduler 125 to dispatch null micro-operations (also referred to as micro-ops or uops) according to some criteria (e.g. temporal).

Each of the above-referenced actions to perturb operations of the respective unit of the processor of FIG. 1 may be invoked and/or controlled by the whitening functional unit state machine 165, the control logic 163 and/or other logic associated with the whitening functional unit 160 in response to events, control, timing or counter information, or other indicator(s) or actions. For actions that are initiated or controlled directly by the whitening functional unit (WFU) 160, the whitening functional unit 160 may include local storage (e.g. data store 168) for one or more code sequences and/or logic that may enable perturbation of operation of one or more units.

In addition to adding bubbles to execution flows and/or communication paths, or controlling units or code to add bubbles to execution flows and/or communication paths, with continuing reference to FIG. 1, the whitening functional unit 160 may also use other approaches to reduce chaotic behavior. For example, in response to detecting one or more loops in the trace cache 110, either using the WFU 160 or other logic on the processor 100, the WFU 160 may infer a resonance and stochastically damp it by adding null micro-operations (also referred to generally herein as null operations or bubbles) to such traces. More complex algorithms for identifying resonances and damping may be useful for some embodiments.

Additionally or alternatively, the whitening functional unit 160 of some embodiments may invoke a lightweight thread 170 designed to add noise to the host system. While the lightweight thread 170 is shown in FIG. 1 as being stored in a local data store 168 on the whitening functional unit 160, it will be appreciated that the lightweight thread 170 may be stored in another memory or otherwise accessible by the whitening functional unit 160.

For one embodiment, the lightweight thread 170 may be designed to execute such that it interferes with or contends with normal operation of one or more functional units to perturb operation. For example, the lightweight thread 170 may generate power events, randomize resource use and/or contend for memory or other resources in a substantially unpredictable or pseudo-random manner.

For some embodiments, there may be more than one lightweight thread with a first thread being designed to perturb operations for a first unit or set of units and one or more other threads being designed to perturb operations for one or more other units. Alternatively, multiple threads may be designed to perturb operations of one or more units in different ways. One or more lightweight threads 170 may even be designed to do useful work in addition to functioning to inject noise to reduce undesired chaotic behavior.

The lightweight thread(s) 170 may be invoked and/or halted by the whitening functional unit 160 in response to events, counter-based or pseudo-random criteria, temporal information, and/or based on other factors, similar to the other whitening approaches described above.

All or portions of the lightweight thread(s) 170 may be designed using one or more known approaches for generating instruction traces that are pseudo-random in time. For example, for one embodiment, a “loop count” may be generated from a pseudo-random number generator. In the lightweight thread program, a loop may be implemented that uses the generated loop count and then exits to retrieve another one. Other approaches for generating such a thread are within the scope of various embodiments.

For embodiments for which a lightweight thread is invoked that generates a pseudo random sequence of events, a frequency analysis and derived power spectrum performed on the retirement times of the instructions in the thread may have a substantially linear power vs. log frequency characteristic across a relatively wide frequency spectrum.

For example, given a time sequence of events (such as retirement times of instructions), e.g. t(1), t(2), t(3), . . . t(n), t(n+1) . . . a spectrum of event frequencies may be built by applying a version of the Fourier transform on the sequence and squaring the amplitudes to determine “power” at each possible frequency. This “power” is unrelated to wafts, but rather it is a measure of the amount of each frequency of a sine wave that is needed such that when added all together, the original time sequence may be synthesized. It is this spectrum which is “flat” (substantially equal “power” at all frequencies) for “white” noise and approaching linear (i.e. declining with increasing frequency on a log scale) for “pink” noise.

With continuing reference to FIG. 1, for other embodiments, other techniques such as repeated and/or random nukes (or other types of commands that disrupt execution flow) and/or partial resets, varying of response latencies in gated clocking systems, introduction of a replay loop in a pipeline and/or introduction of clock jitter (e.g. by changing the clock period arbitrarily from one clock edge to the next) may be additionally or alternatively used to inject noise. One or more of these approaches may be initiated or controlled by the whitening functional unit 160 using the control logic 163, the state machine 165, one or more routines stored in data store 170 and/or other logic or instructions either within or outside of the whitening functional unit. Other operations or actions that function to perturb or alter operations to control undesired chaotic behaviors are within the scope of various embodiments.

For one embodiment, the whitening functional unit 160 is externally accessible for hardware and/or software control via one or more pins, ports (e.g. test ports) micro-operations or other hardware and/or software control mechanisms. Further, for some embodiments, as described above, one or more of the noise injecting operations controlled by the whitening functional unit may be under the algorithmic control of the whitening functional unit state machine 165, which may be initiated and/or halted through external or internal control mechanisms.

While the whitening functional unit 160 is represented in FIG. 1 using a single block for ease of illustration, for some embodiments, the whitening functional unit may not necessarily be physically contiguous and/or may be arranged in a different manner. Various aspects of the WFU 160 may, for example, be distributed throughout the floor plan of the integrated circuit (or system) with which it interacts. The distribution and/or layout of the whitening functional unit of various embodiments may depend on several factors such as, for example, proximity to logic controlled by parts of the whitening functional unit, space constraints, performance considerations, etc.

With continuing reference to FIG. 1, for some embodiments, in addition to injecting noise to reduce undesired chaotic behavior, the whitening functional unit 160 of some embodiments may also be useful in enhancing the security of threads of execution. Recently, with the increasing importance of trusted computing, there has been a concern that programs may be able to discover information in the behavior of a processor that may lead to the violation of another, trusted program. This observation is related to local determinism in processor behavior.

By adding non-determinism to the behavior of a processor by perturbing its operation in some way, the whitening functional unit 160 may be able to obfuscate revealing regularities, and thereby enhance the security of threads of execution.

While a few example approaches for determining when to perturb operations of one or more functional units are described herein, it will be appreciated by those of ordinary skill in the art that a variety of other approaches may be used for other embodiments. The decisions about how and when to initiate such actions may be up to the designer and may be dependent upon a variety of factors. For example, the actions initiated and/or controlled by the whitening functional unit to reduce undesired chaotic behavior may be balanced versus desired performance goals. Other factors such as, for example, space considerations for additional control logic, code storage, etc., may also be taken into account in designing the whitening functional unit 160 and the whitening approaches to be used.

Further, the whitening functional unit of one or more embodiments may be designed to be turned on and/or off (or enabled and/or disabled) at will or in response to given criteria and/or conditions. For example, there may be some applications that are so well understood, optimized and/or considered free of security needs that the whitening functional unit should be turned off based on a high confidence level that the processor (or other circuit or system, for example) will not get stuck in a low performance mode and it has already been designed for high performance.

While the example embodiments described above are in reference to a single core processor, it will be appreciated that similar approaches for reducing undesired chaotic behavior may be implemented for a dual or multi-core processor. In fact, undesired chaotic behavior and/or the security concerns mentioned above may be even more of an issue for multi-core processors.

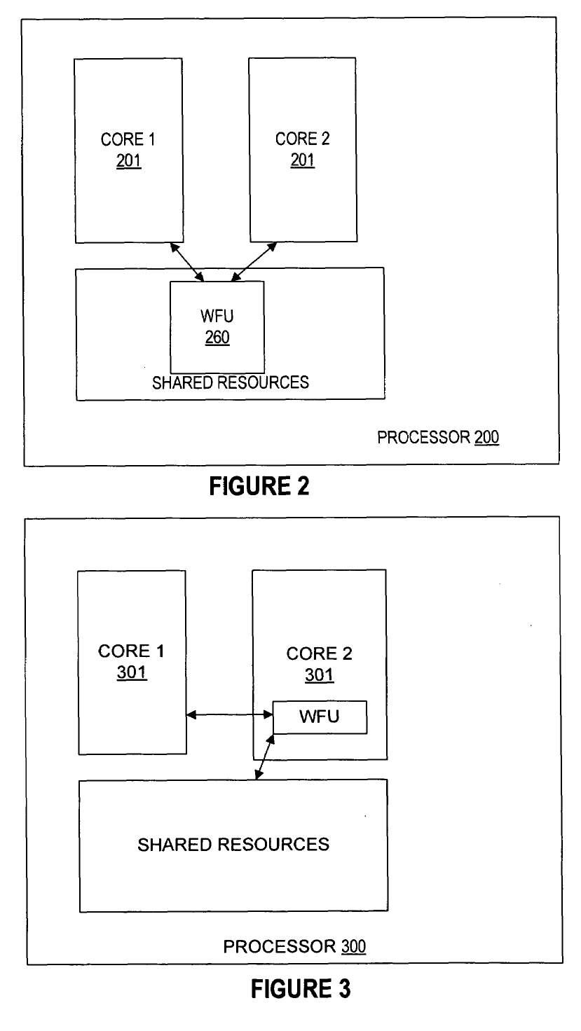

Referring to FIG. 2, which illustrates a dual core processor, for such embodiments, the whitening functional unit 260 may be implemented as a shared resource for the multiple cores. Alternatively, as shown in FIG. 3, the whitening functional unit 360 may be implemented in one of the cores 301 and operate to inject noise into operations of one or more of the other cores 302. While only one whitening functional unit is shown in each of FIGS. 2 and 3, it will be appreciated that multiple whitening functional units may be provided for multi-core processors and may be implemented either within or outside the one or more cores. Further, as for the whitening functional unit 160 of FIG. 1, the whitening functional unit(s) for multi-core processors may not necessarily be physically contiguous and may have a structure and/or layout based on a variety of factors such as space and performance considerations, etc.

For embodiments including multi-core processors, the whitening functional unit 260 or 360 may implement whitening approaches similar to those described above for one or more of the multiple cores, either concurrently or at different times. The whitening functional unit 260 or 360 may further be capable of implementing multiple, different whitening approaches for the multiple cores either concurrently or at different times.

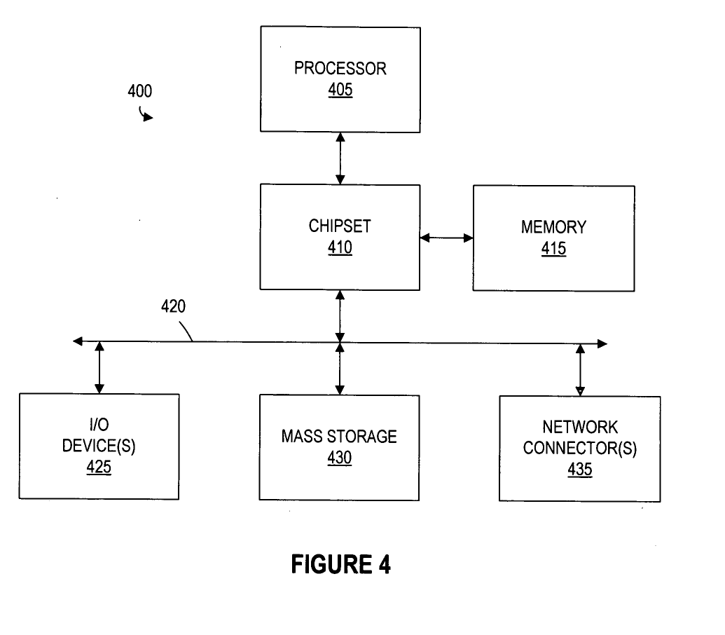

The examples above have been illustrated with reference to processors. The whitening approaches of one or more embodiments, however, may also be used to control undesired chaotic behavior in other types of integrated circuits, systems, platforms and/or groups of systems or platforms. FIG. 4 is a high-level block diagram of an example system 400 in which the whitening approaches of one or more embodiments may be advantageously implemented.

For the embodiment shown in FIG. 4, a whitening functional unit 460 may be implemented in, for example, the chipset, and may function to control whitening for other integrated circuits or portions of integrated circuits within the system 400 in response to various criteria as described above.

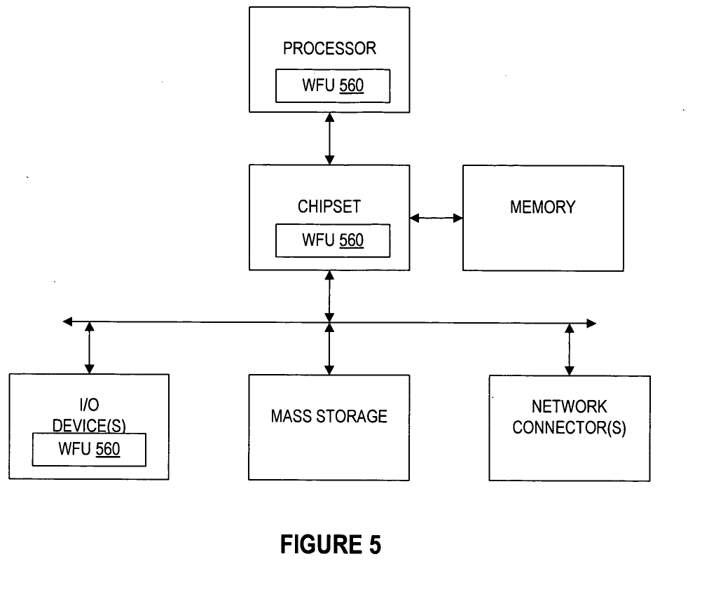

Alternatively, as shown in FIG. 5, there may be multiple whitening functional units 560 distributed throughout the system 500. The multiple whitening functional units 560 may or may not communicate with each other and/or may include multiple sub-units within the individual integrated circuits in which they are implemented.

The whitening functional units 460 and/or 560 of FIGS. 4 and 5 may implement one or more of the whitening approaches described above. Further, the whitening functional unit(s) 460 and/or 560 may implement additional whitening approaches that are designed to reduce undesired chaotic behavior in the system, platform or group of systems or platforms in which they are implemented.

Given that whitening for the embodiments described herein should not change the results of computations, but only the timings, two runs of the same program, where whitening is being used, may have different timings and may, therefore, travel different paths. This may permit a certain degree of useful validation and cross-checking between multiple runs (either simultaneously in different cores or successively in one core). The validation may be useful because many bugs are timing related and the whitening functional unit of one or more embodiments may cause jitter in gross timing.

It will be appreciated that systems configured in a different manner and including different elements may also advantageously implement the whitening approach of one or more embodiments. Further, while certain element(s) of the systems 400 and 500 are illustrated as including whitening functional units, it will be appreciated that, for other embodiments, whitening functional units may be implemented in different elements.

The determination of whether to use one or more whitening functional units in a multi-core, system, platform or multi-system or multi-platform design is a design decision based on tradeoffs such as power, space, complexity, etc. Further, it will be appreciated that whitening in accordance with various embodiments may be implemented at any level, from an individual integrated circuit to a large farm of linux servers and beyond.

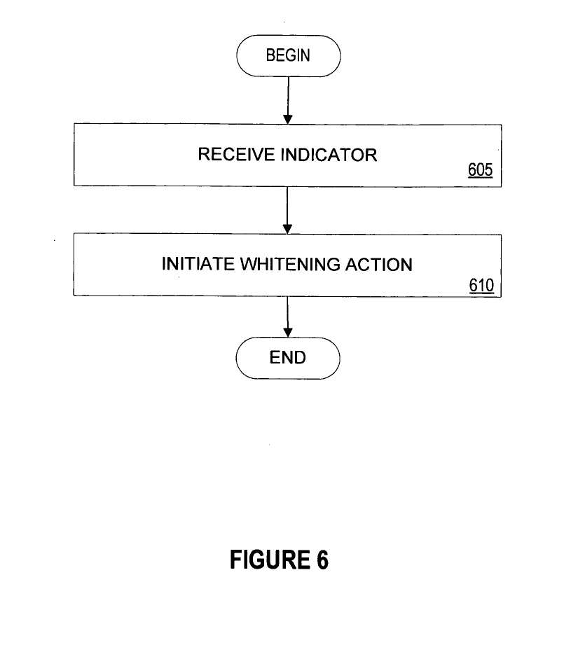

FIG. 6 is a flow diagram showing the method of one embodiment for controlling chaotic behavior. At block 605, an indicator, such as, for example, a given event(s), counter value(s) and/or other indicator(s), a temporal pattern(s), such as a pseudo-random temporal pattern, temporal information, etc.. At block 610, a whitening action is initiated. The whitening action(s) may include, for example, executing a lightweight thread, inserting bubble(s) into an execution path, repeated and/or random nukes or partial resets, varying of response latencies in gated clocking systems, introduction of a replay loop in a pipeline and/or introduction of clock jitter (e.g. by changing the clock period arbitrarily from one clock edge to the next), and/or other actions.

It will be appreciated that the methods of various embodiments may include additional actions or may not include actions described in reference to FIG. 6. For example, for some embodiments, whitening actions may occur other than in response to an indicator. Other actions described herein are within the scope of one or more embodiments.

Using the whitening approach(es) of one or more embodiments, it may be possible for performance excursions to be monitored and suppressed in a sense similar to that of thermal sensing, which currently permits the monitoring and sensing of thermal excursions. This may be a desirable feature for customers who need predictable performance on their workloads. Also, the whitening approach(es) of one or more embodiments may reduce the a priori likelihood of a catastrophic system lockup due to an unforeseen timing interaction, resource starvation, livelock or deadlock, for example. This reduction of likelihood is a natural consequence of the suppression of performance excursions mentioned above. Further, overall “average” performances may actually increase due to the prevention of wide performance excursions that may result from using the whitening approach(es) of one or more embodiments.

For some embodiments, the presence of a whitening functional unit in a design may permit designers/architects to whiten their simulations to reduce anomalous performance data, which cost simulation cycles while providing little or no information. Additionally, the whitening approach of one or more embodiments may enhance the security of execution threads, such as BIOS patches and their descendents.

Thus, various embodiments and approaches for controlling chaotic behavior in a microprocessor or other complex logic arrangement are described. In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus comprising:
a whitening functional unit coupled to a first functional unit, the whitening functional unit to perturb the operation of the first functional unit in a substantially non-deterministic manner.

2. The apparatus of claim 1 wherein the whitening functional unit is to perturb operation by causing at least one of insertion of one or more null operations, execution of a lightweight thread, variation of a latency, introduction of clock jitter, execution of a replay loop, marking of cache lines substantially at random, and execution of an instruction that disrupts execution flow.

3. The apparatus of claim 2 wherein the whitening functional unit and the first functional unit are integrated within a microprocessor.

4. The apparatus of claim 3 wherein the whitening functional unit is coupled to a microcode read only memory (ROM) and is to perturb operation using microcode stored in the ROM.

5. The apparatus of claim 4 wherein the microprocessor includes at least two cores.

6. The apparatus of claim 2 wherein the whitening functional unit is integrated into a first integrated circuit within a system and the first functional unit is on a second integrated circuit within the system.

7. The apparatus of claim 2 wherein the whitening functional unit is integrated into a first system and the first functional unit is a second system.

8. The apparatus of claim 2 wherein the whitening functional unit is further coupled to a second functional unit and is further to perturb the operation of the second functional unit in a substantially non-deterministic manner.

9. The apparatus of claim 1 wherein the whitening functional unit is responsive to one of a source of pink noise, a source of white noise, a pseudo-random number generator and a counter to initiate perturbation of operation.

10. A microprocessor comprising:
a microcode read only memory;
a first functional unit; and
a whitening functional unit to perturb operation of the first functional unit in a substantially non-deterministic manner.

11. The microprocessor of claim 10 wherein the first functional unit is one of a memory execution unit, a front side bus interface unit, a cache memory, and an execution unit.

12. The microprocessor of claim 11 wherein the whitening functional unit is further to perturb operation of at least a second functional unit in a substantially non-deterministic manner.

13. The microprocessor of claim 12 wherein the whitening functional unit is responsive to one of a counter, pseudo-random number generator and a source of noise to perturb operation of at least one of the first and second functional units.

14. The microprocessor of claim 10 wherein the whitening functional unit is to perturb operation by causing at least one of insertion of one or more null operations, execution of a lightweight thread, variation of a latency, introduction of clock jitter, execution of a replay loop, marking of cache lines substantially at random, and execution of an instruction that disrupts execution flow.

15. The microprocessor of claim 10 wherein the whitening functional unit is responsive to one of an event and control information to perturb operation of the first functional unit.

16. The microprocessor of claim 10 including at least a first processor core and a second processor core.

17. The microprocessor of claim 16 wherein the first functional unit is integrated into the first processor core and the whitening functional unit is integrated into the second processor core.

18. A method comprising:
receiving an indicator; and
responsive to the indicator, perturbing operation of at least a first functional unit in a substantially non-deterministic manner.

19. The method of claim 18 wherein receiving an indicator includes receiving one of pseudo random information, a counter value, control information, indication of the occurrence of an event and a signal from a noise source.

20. The method of claim 18 wherein perturbing operation includes at least one of inserting one or more null operations, executing a lightweight thread, varying a latency, introducing clock jitter, executing a replay loop, marking cache lines substantially at random, and executing an instruction that disrupts execution flow.

21. A system comprising:
a processor;
a bus coupled to the processor to communicate information;
a network connector coupled to the bus to connect to a network; and
a whitening functional unit to perturb operation of the processor in a substantially non-deterministic manner.

22. The system of claim 21 further comprising a chipset coupled to the bus and the processor, wherein the whitening functional unit is integrated into one of the chipset and the processor.

23. The system of claim 21 wherein the whitening functional unit is to perturb operation of the processor by causing at least one of insertion of one or more null operations, execution of a lightweight thread, variation of a latency, introduction of clock jitter, execution of a replay loop, marking of cache lines substantially at random, and execution of an instruction that disrupts execution flow.
